(19) United States
(12) Patent Application Publication
(10) Pub. No.: US 2014/0367312 A1
(43) Pub. Date: Dec. 18, 2014

(54) APPARATUS AND A METHOD FOR SORTING A PARTICULATE MATERIAL

(71) Applicants: John Clarence Box, Perth (AU); Vladimir Arkadievich Golovanevskiy, Parkwood (AU)

(72) Inventors: John Clarence Box, Perth (AU); Vladimir Arkadievich Golovanevskiy, Parkwood (AU)

(73) Assignee: CURTIN UNIVERSITY OF TECHNOLOGY, Bentley, Western Australia (AU)

(21) Appl. No.: 14/355,996

(22) PCT Filed: Aug. 6, 2012
(86) PCT No.: PCT/AU2012/000922

§ 371 Date: Aug. 28, 2014

(30) Foreign Application Priority Data
Nov. 4, 2011 (AU) 2011904588

(51) Int. Cl. B03C 1/025; B03C 1/00; B03C 1/26

(52) U.S. Cl. CPC B03C 1/025; B03C 1/26; B03C 1/002
USPC 209/224

(57) ABSTRACT

The present disclosure provides an apparatus for sorting a particulate material. The apparatus comprises a receiving portion for receiving the particulate material having a particle size within a predetermined range of sizes. The apparatus also comprises a distributor for receiving the particulate material at an upper end thereof and having a sloped distribution surface along which, in use, the particulate material passes substantially by gravity. A surface area of the sloped distribution surface increases towards a lower end of the distributor to facilitate a monolayer feed stream of the particles exiting and falling from a lower end of the distributor distributed as a curtain-like stream of particles. The apparatus further comprises a magnetic element for generating a magnetic force that is directed such that the particles of the falling feed stream that exit the lower end of the distributor have pathways that depend on magnetic properties of the particles. The apparatus also comprises sorting portions for sorting the particles based on the pathways of the particles.

### FIELD OF THE INVENTION

The present invention relates to an apparatus and a method for sorting a particulate material and relates particularly, though not exclusively, to an apparatus and a method for sorting a mined material such as iron ore.

### BACKGROUND OF THE INVENTION

Mining of large quantities of iron ore is required to satisfy increasing demands for steel products. The mined iron ore typically comprises a mixture of waste materials such as rock and iron containing minerals, such as magnetite, hematite or goethite.

Further, iron ores have different grades and especially high grade iron ore, containing a large proportion of iron, is of interest for further processing. Consequently, being able separate the rock form the iron containing minerals is important, but it would be ideal if the iron containing minerals could also be sorted into different types or grades in an efficient manner.

Different sorting apparatus for sorting the material into mined material and waste have been proposed.

Russian patent document SU 1002007 discloses an apparatus for sorting of bulk materials. The bulk material to be sorted is distributed by a rotating flat feeder and then guided through a magnetic field inside a rotating housing. Non-magnetic particles are removed from the material by centrifugal forces created by the rotating housing and magnetic particles travel downwards along the surface of the housing attracted by magnetic forces. At the bottom of the apparatus the magnetic particles are detached from the surface of the rotating housing using compressed air.

Chinese patent document CN 21505573 discloses an apparatus for sorting small particles having a diameter of up to 10 mm. The particles are received by a vibrating feeder from a chute and then fed into a gap at a rotating magnetic drum: From the surface of the rotating magnetic drum, magnetic particles slide sideways into a first chute and waste (i.e. non-magnetic) particles fall under gravity into a second chute.

Japanese patent document JP 0007155639 discloses an apparatus for magnetic separation of fine ore into two streams (i.e. product and waste). The fine ore material is loaded via a feeding hopper onto the concave surface of separation spirals. Magnetic particles (i.e. iron containing particles) are attracted to the surface of a rotating drum that is positioned at a centre, of the separation spiral and then directed into a first chute. Non-magnetic particles (i.e. waste) slide off the separation spiral and fall into a second chute.

A number of shortcomings have been identified with these known sorting apparatuses. They are generally unsuited for large-scale sorting of mined material due to the complexity of the involved mechanisms typically involving a number of interacting and/or moving parts to sort the material. This makes them generally unsuitable for large volumes of mined material, as well as raising the probability for requiring frequent maintenance resulting in reduced reliability. In addition, the known apparatuses are generally configured to sort material into discrete magnetic and non-magnetic components only, instead of allowing for sorting into a multitude or grades of sorted material based on a magnetic response of the material to be sorted.

The present invention seeks to propose a possible solution to these shortcomings, having particular application in large-scale, sorting of mined material.

### SUMMARY OF THE INVENTION

The present invention provides in a first aspect an apparatus for sorting a particulate material, the apparatus comprising:

a receiving portion for receiving the particulate material having particle sizes within a predetermined range of sizes;

a distributor for receiving the particulate material at an upper end thereof and having a sloped distribution surface along which, in use, the particulate material passes substantially by gravity, a surface area of the sloped distribution surface increasing towards a lower end thereof to facilitate formation of a monolayer feed stream of the particles exiting and falling from a lower end of the distributor distributed as a curtain-like stream of particles; and

a magnetic element for generating a magnetic force that is directed such that the falling particles that exit the lower end of the distributor have pathways that depend on magnetic properties of the particles; and

sorting portions for sorting the particles based on the pathways of the particles.

The term “particulate material” as used herein is intended to encompass any matter, material or object whether it is naturally occurring or manmade and which is in the form of discrete particles or granules. Consequently, it is to be appreciated that the present invention is not limited to the sorting of iron ore even though some embodiment of the present invention focus on iron ore as an example of the particulate material.

The term “monolayer” as used herein in the context of particulate material is understood to refer to a layer of particles having a depth or thickness of approximately one particle. It is to be appreciated that having a curtain-like monolayer of particles subjected to a magnetic force facilitates sorting of the material without undue interaction between neighbouring particles which may influence sorting of such particles.

Embodiments of the present invention have significant practical advantages. The distribution surface of the distributor is shaped such that formation of the monolayer of the particles is facilitated for large throughput or volume of material. Further, the apparatus may be arranged such that the particles falling from the distributor may be directed in any number of pathways or falling trajectories (e.g. based on different magnetic properties of different ore grades) and sorted accordingly. In addition, embodiments of the apparatus have no moving parts drastically increasing mechanical reliability and an associated reduction in maintenance.

The slope (or portion thereof) of the distribution surface along which the particulate material passes (tumbles, falls, rolls or otherwise moves) may define any suitable angle relative to a vertical axis, such as at least 20°, at least 40°, or at least 60°. The slope may be curved or straight.

In one embodiment of the present invention the distribution surface has a round or rounded cross-sectional shape and may have a conical shape. The distributor may in this case be arranged such that the feed stream of the particulate material forms a ring, segment or portion thereof.

The distributor may have a vibrator that is arranged to facilitate passing of the particulate material through the distributor by vibration and thereby facilitate throughput of large quantities of the particulate material.

The receiving portion may be arranged for feeding by gravity.

The magnetic element may be arranged to generate any suitable magnetic field and in one specific example is arranged such that a resultant magnetic force has a main component or direction that is perpendicular to the direction of the feed stream that in use exits the distributor.

The magnetic element is typically arranged such that the magnetic force is directed towards or away from a vertical axis of the distributor. The magnetic element may comprise components that are positioned such that in use the feed stream of the particulate material substantially surrounds the magnetic element and/or the magnetic element substantially surrounds the feed stream of the particulate material.

The magnetic element may comprise segments that together are arranged to generate the magnetic force. Further, the magnetic element, which in one specific example is an electro-magnetic element, or a rare-earth magnet, may be arranged such that the strength of the magnetic force can be varied. For example, the magnetic element may be arranged so that the magnetic force may be varied electrically. Alternatively, the magnetic element may be arranged so that the magnetic force may be mechanically varied such as by varying a distance. It is also to be appreciated that different aspects of the magnetic field may be varied, i.e. the range, distribution, etc. It is anticipated that such variance may be utilised to facilitate sorting of the particles in a useful manner depending on sorting requirements.

The magnetic element typically is arranged to generate a magnetic, field having a strength of approximately 0.5-2. 2-4, 4-6, 6-8, or 8-10 Tesla.

The sorting portions may be chutes or bins or may take any other suitable form.

In one specific embodiment the apparatus has first and second sorting chutes and is arranged to divide the particulate material into two portions. In this embodiment the apparatus comprises an intermediate chute portion that is located between the distributor and the sorting chutes and located adjacent to the magnetic element such that the feed stream of the particulate material is exposed to the magnetic force when passing through the intermediate chute portion. The intermediate chute portion is typically coupled to the sorting chutes such that the magnetic force influences the pathways of the particles in the intermediate chute portion and the particles are then directed into the sorting chutes. The intermediate chute portion may have any suitable diameter, such as a diameter of less than 50, 20, 10, 7, 6, 5 or 3 times the average size of the particles.

As discussed above, the particulate material may be any type of material, but in one specific example comprises or is provided in the form of a mined material such as iron ore. The apparatus may be arranged for separating iron ore particles having an iron concentration above a threshold concentration, such as more than 55% iron concentration by weight (high grade iron ore contains more than 55% iron by weight) from remaining particles. The apparatus may be arranged such that iron ore having an iron concentration above a threshold concentration is directed into the first sorting chute and the remaining iron ore is directed into the second sorting chute, e.g. the remaining iron ore falls into the second sorting chute under the influence of gravity largely unaffected by the magnetic force. Further, the apparatus may be arranged to separate magnetite, hematite and goethite minerals from each other and/or from other particles of the iron ore, such as rock particles.

The apparatus may also comprise an arrangement for drying the particulate material prior to directing the particulate material into the distributor.

Further, the apparatus may comprise an arrangement for fractioning material to generate the particulate material having particle sizes within the predetermined range of particle sizes.

The predetermined range of sizes of the particles may for example be 1 mm-10 mm, 10 mm-25 mm, 25 mm-50 mm or 50 mm-80 mm. The particles typically have an average maximum to minimum particle size ratio between 2:1 to 3:1 wherein the average maximum particle size is between two to three times the size of an average minimum particle size.

The apparatus may also be one of a plurality of apparatus each of which being arranged to sort particulate material having particles of a different size range.

The present invention provides in a second aspect an apparatus for sorting iron ore, the iron ore being provided in the form of a particulate material, the apparatus comprising:
a receiving portion for receiving iron ore in the form of particles having sizes within a predetermined range of sizes;
a distributor for receiving the iron ore at an upper end thereof and having a sloped distribution surface along which, in use, the iron ore passes substantially by gravity, a surface area of the sloped distribution surface increasing towards a lower end thereof to facilitate formation of a monolayer feed stream of iron ore particles exiting and falling from a lower end of the distributor distributed as a curtain-like stream of particles;
a magnetic element for generating a magnetic force that is directed such that the falling particles that exits the lower end of the distributor have pathways that depend on magnetic properties of the particles; and sorting portions for sorting the iron ore particles based on pathways of the iron ore particles.

The present invention provides in a third aspect a method of sorting particulate material, the method comprising:
receiving the particulate material, at least some of the particles of the particulate material having sizes within a predetermined range of sizes;
passing the particulate material along a distribution surface of a distributor substantially by gravity such that the particles are distributed across an increasing area when the particles move along the distribution surface and a monolayer feed stream of particles having the size within the predetermined range of sizes exits and falls from the distributor; and
exposing the falling particles of the particulate material to a magnetic force that is arranged such that the falling particles have pathways that are influenced by magnetic properties of the particles; and
sorting the particles based on the magnetic properties of the particles.

The step of passing the particulate material along a distribution surface may comprise passing the particulate material along a conical distribution surface.

The step of exposing the generated feed stream of the particulate material to a magnetic force may comprise controlling the magnetic force to select pathways of the particles.

The step of sorting the particles based on magnetic properties of the particles may comprise sorting the particles into two or more streams of the particles.

The particulate material may be provided in any suitable form, but in one specific example comprises a mined material such as iron ore. For example, the method may comprise directing particles having an iron concentration above a threshold concentration (such as more than 55% iron concentration by weight) into a first sorting chute and the remaining particles into a second sorting chute.

In one specific embodiment the method is conducted using the apparatus of the first or second aspects of the present invention.

The invention will be more fully understood from the following description of specific embodiments of the invention. The description is provided with reference to the accompanying drawings.

### BRIEF DESCRIPTION OF THE DRAWINGS

FIG. 1 is a schematic cross-sectional side view of an apparatus in accordance with a specific embodiment of the present invention;

FIG. 2 is a schematic cross-sectional presentation of the apparatus shown in FIG. 1 as viewed in the direction of arrows of FIG. 1 and along cut A-A′; and

FIG. 3 is a flow chart illustrating a method in accordance with a specific embodiment of the present invention.

### DETAILED DESCRIPTION OF SPECIFIC EMBODIMENTS

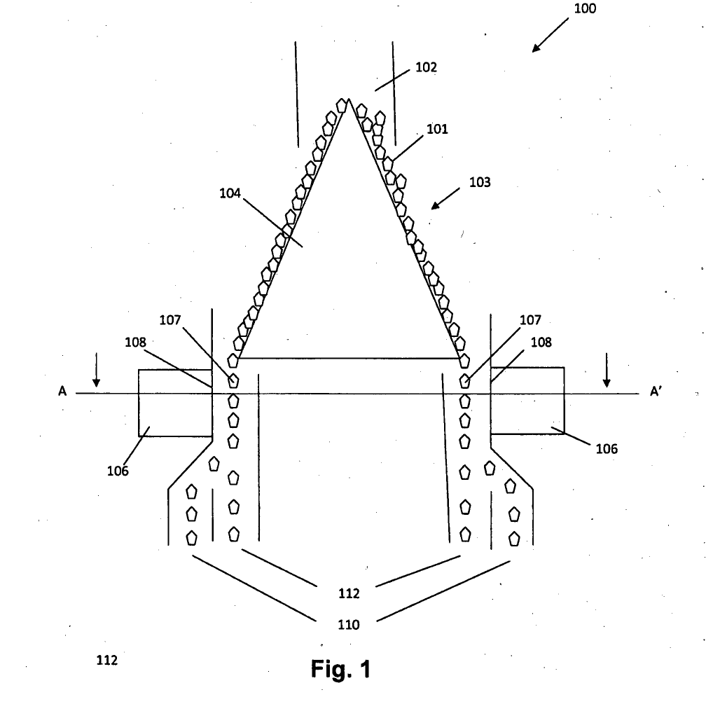

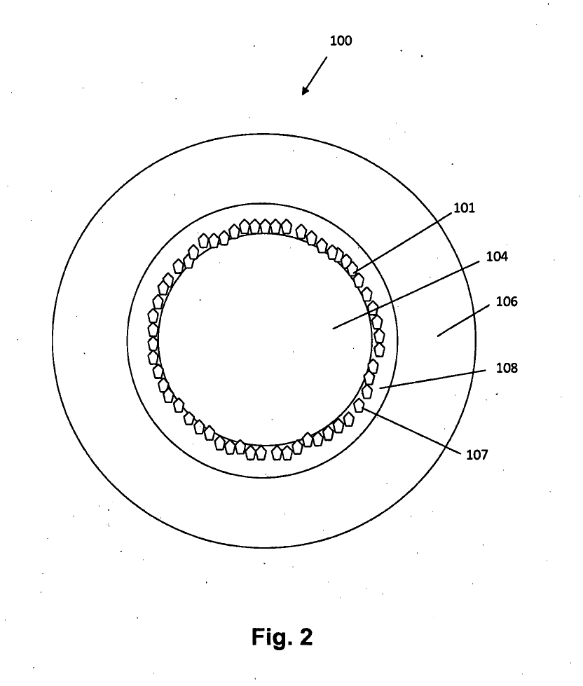

Referring now to FIGS. 1 to 3, an apparatus and a method for sorting particulate material in accordance with specific embodiments of the present invention are described. The apparatus 100 illustrated in FIGS. 1 and 2 is arranged for sorting particulate material 101 such as iron ore. The apparatus 100 has a receiving portion or feed bin 102 by which the particulate material 101 is received and comprises a distributor 103 that is arranged to distribute the received particulate material 101 such that a monolayer feed stream 107 of the particulate material falls from the distributor 103. The apparatus 100 is arranged for throughput of the particulate material by gravity.

In this embodiment the distributor 103 comprises a conical distribution surface 104 and the particles of the particulate material 101 slide, roll, tumble or otherwise move down the conical distribution surface 104 generally under the influence of gravity. The slope, size of the conical distribution surface 104 and feeding quantities are chosen such that a ring-like curtain of free-falling particulate material having a monolayer thickness is generated and exits the distributor 103.

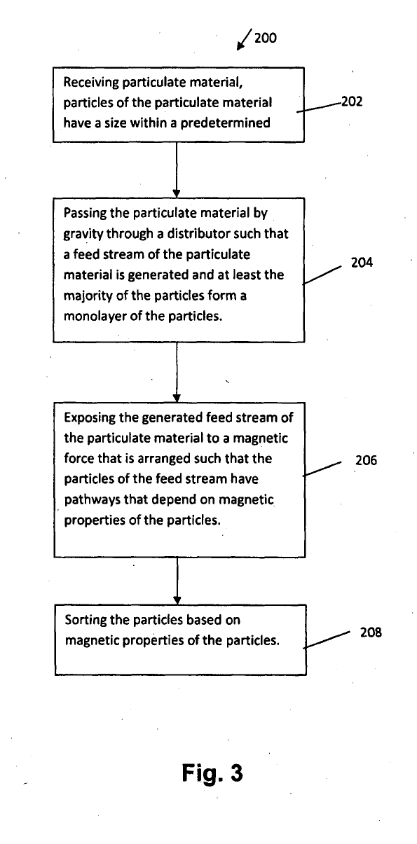

Accordingly, method 200 illustrated in FIG. 3 comprises the step 202 of receiving the particulate material having particles that have a size within a predetermined range of sizes. Further, the method 200 comprises step 204 of passing the particular material by gravity through a distributor such that a feed stream of particulate material is generated and at least a majority of particulates form a monolayer feed stream of the particles.

The distributor 103 in this embodiment has a base (bottom) diameter that is of the order of 4 meters. The throughput of the particulate material 101 is facilitated using a vibrator (not shown) that vibrates the distributor 103 and the distributor 103 is arranged such that the monolayer feed stream is generated with a vertical particle velocity between 1 and 5 m/s.

Preparation of the particulate material 101 comprises the initial step of fractioning larger particles such that particles having an average size of 1 mm-10 mm, 10 mm-25 mm, 25 mm-50 mm or 50 mm-80 mm (depending on embodiments of the invention) are formed. Further, the particulate material 101 may be dried prior to sorting of the particulate material 101. For these purposes conventional fractioners and dryers may be used that are well known by a person skilled in the art and not described in further detail.

After exiting the distributor 103, the particulate material enters an intermediate chute portion or distribution chute 108 and is exposed to a magnetic force generated by a magnetic element 106. The distribution chute 108 is connected to sorting chutes 110 and 112. The magnetic element 106 is operated such that a magnetic force is generated that has a strength sufficient to sort particles of the particular material 101 by magnetic properties in sorting chutes 110 and 112.

The magnetic element 106 comprises in this example superconducting electric magnets that surround the ring-like stream of the particulate material. However, it is to be appreciated that in an alternative embodiment the magnetic element 106 may also comprise conventional electrical magnets that are arranged to generate a magnetic field of sufficient strength. Further, magnetic coils comprising such an electrical magnet may alternatively be positioned inside the ring-like stream of the particulate material. The strength of the magnetic field that is developed by the magnetic element 106 ranges from 0.5 to 10 or more Tesla and is varied to suit particular applications and the size of the particles.

The distribution chute 108 has a ring-like cross-sectional shape and is proportioned such that the distance between walls of the distribution chute is approximately 5 times the size of particles of the particulate material 101.

In one specific example the apparatus is arranged to sort iron ore particles. The magnetic properties of particles of the iron ore depend on the composition of the minerals and the grade of the iron ore and it is possible to separate high grade iron ore from low grade iron ore. Low grade iron ore contains more particles with a large portion of non iron bearing materials such as alumina, silica and phosphorous and high grade iron ore contains more than 55% iron by weight. There are different types of iron containing minerals, such as magnetite, hematite and goethite, which have magnetic susceptibilities of 80,000, 290 and 25×10⁶ cm³/g, respectively. Consequently, it is also possible to distinguish these materials from each other by exposing these minerals to magnetic forces.

The generated magnetic field results in different magnetic forces for each particle that has different magnetic properties and embodiments of the present invention sort materials based on trajectories of the particles in the distribution chute 108. In one example, the magnetic element 106 is operated such that magnetic forces will influence pathways of the particles in a manner such that particles having an iron ore grade above a threshold grade (such as above 55% iron content by weight) will be directed in one of the chutes 110 and 112 and particles having an iron ore grade below that threshold grade will be directed into the other one of the chutes 110 and 112. It is also to be appreciated that some particles may not be directed, as such, but will be unaffected by the magnetic force and will be sorted accordingly.

In one embodiment, the chutes 110 and 112 direct the sorted particular material to conveyor belts (not shown), which transport the sorted particular material 101 for further processing.

Accordingly, the method 200 comprises step 206 of exposing the generated feed stream of particulate material to a magnetic force that is arranged such that the particles of the feed stream have pathways that depend on magnetic properties of the particles. Further, the method 200 comprises the step of sorting the particles based on magnetic properties of particles.

It is to be appreciated by a person skilled in the art that the apparatus 100 may be provided in a variety of different forms. For example, the apparatus 100 may not necessarily be arranged to generate a ring-like curtain of free-falling particulate material, but may be arranged to generate an arc-like curtain of the free-falling matter. In addition, the apparatus 100 may be arranged to sort the particular material into more than 2 portions and may have distribution chutes in which the particular material is directed into respective chutes of a type similar to chutes 110 and 112.

The Applicant is of the opinion that one possible advantage of the current invention is that high particulate material throughput rates can be achieved through the apparatus whilst accurately sorting the particulate material. A further aspect which is believed to be advantageous is that the apparatus does not require any conventional air or fluid blast separation technologies, as is common in the art, in order to sort the particulate material.

1. An apparatus for sorting a particulate material, the apparatus comprising:
a receiving portion for receiving the particulate material having a particle size within a predetermined range of sizes;
a distributor for receiving the particulate material at an upper end thereof and having a conical distribution surface along which, in use, the particulate material passes substantially by gravity, the conical distribution surface being positioned such that a surface area of the conical distribution surface increases towards a lower end thereof to facilitate formation of a monolayer feed stream of the particles exiting and free falling from a lower end of the distributor distributed as a curtain-like stream of particles; and
a magnetic element for generating a magnetic force that is directed towards or away from a vertical axis of the distributor such that the falling particles that exit the lower end of the distributor have pathways that depend on magnetic properties of the particles; and
sorting portions for sorting the particles based on the pathways of the particles.

2. The apparatus of claim 1 wherein the distribution surface has a round or rounded cross-sectional shape.

3. (canceled)

4. The apparatus of claim 1 wherein the distributor is arranged such that the feed stream of the particulate material defines a ring or portion thereof.

5. The apparatus of claim 1 wherein a slope of the conical surface is straight.

6. The apparatus of claim 1 wherein a slope of the conical surface is curved.

7. The apparatus of claim 1 wherein the receiving portion is arranged for feeding by gravity.

8. The apparatus of claim 1 wherein the magnetic element is arranged such that the magnetic force has a main component or direction that is perpendicular to the direction of the feed stream that in use exits the distributor.

9. (canceled)

10. The apparatus of claim 1 wherein the magnetic element comprises components that are positioned such that in use the feed stream of the particulate material substantially surrounds the magnetic element.

11. The apparatus of claim 1 wherein the magnetic element comprises components that are positioned such that in use the magnetic element substantially surrounds the feed stream of the particulate material.

12. The apparatus of claim 1 wherein the magnetic element is an electro-magnetic element and wherein the magnetic element is arranged such that the strength of the magnetic force can be varied electrically.

13. The apparatus of claim 1 wherein the magnetic element is arranged such that the strength of the magnetic force can be varied mechanically.

14. (canceled)

15. The apparatus of claim 1 wherein the apparatus comprises an intermediate chute portion that is located between the distributor and the sorting portions and located adjacent to the magnetic element such that the feed stream of the particulate material is exposed to the magnetic force when passing through the intermediate chute portion.

16. The apparatus of claim 15 wherein the intermediate chute portion is coupled to the sorting portions such that the magnetic force influences the pathways of the particles in the intermediate chute portion and the particles are then directed into the sorting portions.

17. The apparatus of claim 15 wherein the intermediate chute portion has a diameter of less than 20 times the average size of the particles.

18-19. (canceled)

20. The apparatus of claim 1 wherein the apparatus is arranged for separating iron ore particles having an iron concentration above a threshold concentration from remaining particles.

21. The apparatus of claim 20 wherein the apparatus is arranged such that iron ore having the concentration above the threshold concentration is directed into a first sorting chute and the remaining particles into a second sorting chute.

22. The apparatus of claim 20 wherein the apparatus is arranged to separate magnetite, hematite and goethite minerals from each other and/or from other particles of the iron ore.

23-26. (canceled)

27. The apparatus of claim 1 wherein the particles have an average maximum to minimum particle size ratio between 2:1 to 3:1 wherein the average maximum particle size is between two to three times the size of an average minimum particle size.

28. (canceled)

29. An apparatus for sorting iron ore, the iron ore being provided in the form of a particulate material, the apparatus comprising:
a receiving portion for receiving iron ore in the form of particles having sizes within a predetermined range of sizes;
a distributor for receiving the iron ore at an upper end thereof and having a conical distribution surface along which, in use, the iron ore passes substantially by gravity, the conical distribution surface being positioned such that a surface area of the conical distribution surface increases towards a lower end thereof to facilitate a monolayer feed stream of iron ore particles exiting and free falling from a lower end of the distributor distributed as a curtain-like stream of particles;
a magnetic element for generating a magnetic force that is directed towards or away from a vertical axis of the distributor such that the falling particles that exit the lower end of the distributor have pathways that depend on magnetic properties of the particles; and
sorting portions for sorting the iron ore particles based on pathways of the iron ore particles.

30. A method of sorting particulate material, the method comprising:
receiving the particulate material having particle sizes within a predetermined range of sizes;
passing the particulate material along a conical distribution surface of a distributor substantially by gravity such that the particles are distributed across an increasing area when the particles move along the distribution surface and a monolayer feed stream of particles having the size within the predetermined range of sizes exits the distributor; and
exposing the generated free falling particles of the particulate material to a magnetic force that is directed towards or away from a vertical axis of the distributor and is arranged such that the falling particles have pathways that are influenced by magnetic properties of the particles; and
sorting the particles based on the magnetic properties of the particles.

31-35. (canceled)
